(19) United States
(12) Patent Application Publication
(10) Pub. No.: US 2024/0365827 A1
(43) Pub. Date: Nov. 7, 2024

(54) CLEAN LABEL SHELF-STABLE FLAVOR DELIVERY SYSTEMS

(71) Applicant: Firmenich SA, Satigny (CH)

(72) Inventors: Valery NORMAND, Plainsboro, NJ (US); Jian ZHANG, Plainsboro, NJ (US); Amanda SCHOBER, Plainsboro, NJ (US); Fei ZHANG, Shanghai (CN); Pierre-Etienne BOUQUERAND, Arbusigny (FR)

(21) Appl. No.: 18/776,458

(22) Filed: Jul. 18, 2024

Related U.S. Application Data
(63) Continuation of application No. 16/626,398, filed on Dec. 24, 2019, now abandoned.
(60) Provisional application No. 62/525,865, filed on Jun. 28, 2017.

(30) Foreign Application Priority Data
Oct. 24, 2017 (EP) 17198115.2

(51) Int. Cl. A23L 27/00; A23L 3/3508; A23L 27/12; A23L 29/25; A23L 29/30

(52) U.S. Cl. CPC A23L 27/88; A23L 3/3508; A23L 27/13; A23L 29/25; A23L 29/30; A23V 2002/00

(57) ABSTRACT

Described herein are particles including flavors having an improved shelf life. Also described herein are methods to produce the particles. Additionally, described herein are beverages, sweet goods, and savory applications containing the particles.

### CROSS-REFERENCE TO RELATED APPLICATIONS

This application is a continuation application of U.S. patent application Ser. No. 16/626,398, filed on Dec. 24, 2019, which is a U.S. National Phase Application of PCT/EP18/67454, filed on Jun. 28, 2018, which claims the benefit of priority to European Patent Application Number 17198115.2, filed Oct. 24, 2017, and to U.S. Provisional Patent Application No. 62/525,865, filed Jun. 28, 2017, the entire contents of which are hereby incorporated by reference herein.

### FIELD OF THE INVENTION

The present disclosure relates to particles comprising flavors having an improved shelf life. In addition, the present disclosure relates to methods to produce the particles. Additionally, the present disclosure relates to beverage, sweet goods, and savory applications containing the particles.

### BACKGROUND

Flavor delivery systems comprising starch derivatives (such as, for example, maltodextrin or modified starch) are less desirable in many food applications, compared to flavor delivery systems containing “clean label” ingredients, such as, for example gum Arabic, plant polysaccharides, and the like. However, the shelf life of flavor delivery systems containing clean label ingredients can be limited, due to oxidation of the flavor.

Accordingly, there is a need for shelf-stable flavor delivery systems containing clean label ingredients.

### SUMMARY

One aspect provides a composition, wherein the composition is a solid, the composition comprising:
a) a biopolymer selected from the group consisting of: a starch, a natural gum derived from a botanical source, a natural gum derived from seaweed, a natural gum derived from bacterial fermentation; a protein derived from plants, and a polysaccharide derived from plants; and
b) a flavor, comprising:
   i. at least one stabilizer, and
   ii. a hedonic component,
      wherein the hedonic component comprises from 10% to 30% of the composition,
      wherein the at least one stabilizer comprises from 4.5% to 27% of the composition, and
      wherein the biopolymer comprises from 49% to 85.5% of the composition.
         One aspect provides a flavor, comprising:
a) at least one stabilizer, and
b) a hedonic component,
   wherein the at least one stabilizer comprises from 10% to 75% of the flavor, and
   wherein the hedonic component comprises from 15% to 90% of the flavor.

In one aspect, the natural gum derived from a botanical source is selected from the group consisting of: gum arabic, gum ghatti, gum tragacanth, Karaya gum, and combinations thereof.

In one aspect, the natural gum derived from a seaweed is selected from the group consisting of: alginate, agar, and carrageenan.

In one aspect, the natural gum derived from bacterial fermentation is gellan gum.

In one aspect, the protein derived from plants is soy protein.

In one aspect, the polysaccharide derived from plants is soy polysaccharides.

In one aspect, the at least one stabilizer is selected from the group consisting of: a plant extract, an organic acid, an organic acid salt, a sugar, honey, and combinations thereof.

In one aspect, the plant extract is a dried plant extract.

In one aspect, the plant extract is a juice extract.

In one aspect, the plant extract is selected from the group consisting of: a pear extract, a citrus fruit extract, a grape extract, a tree sap, and combinations thereof.

In one aspect, the citrus fruit extract is selected from the group consisting of: an orange extract and a lemon extract.

In one aspect, the tree sap is maple syrup.

In one aspect, the organic acid is selected from the group consisting of: citric acid, malic acid, ascorbic acid, tartaric acid, and combinations thereof.

One aspect provides a powdered beverage comprising a composition according to some aspects presented herein.

One aspect provides a sweet good comprising a composition according to some aspects presented herein.

One aspect provides a savory good comprising a composition according to some aspects presented herein.

### BRIEF DESCRIPTION OF THE FIGURES

FIG. 1 shows a schematic illustration of the structure of the arabinogalactan protein complex of gum arabic.

FIG. 2 shows the effect of a stabilizer comprising sugar on the specific volume (Vₛₚ) of gum arabic. All carriers were spray dried with 20% wt orange oil. The standard deviation of Vₛₚ for these samples is <0.001 cm³/g.

FIG. 3 shows the effect of a stabilizer comprising sugar on the oxidation of a hedonic component comprising limonene. All carriers were spray dried with 20% wt orange oil. OPs stands for oxidation products including limonene oxide and carvone. Powders were stored at 35° C.

FIG. 4 shows the effect of organic acids on the specific volume (Vₛₚ) of gum arabic. All carriers were spray dried with 20% orange oil. The standard deviation of Vₛₚ for these samples is <0.001 cm³/g.

FIG. 5 shows the concentration of oxidation products over time in storage of compositions containing 7.5% glycerol or organic acid. The control contains no organic acid. OPs stands for oxidation products including limonene oxide and carvone. Powders were stored at 35° C.

FIG. 6 shows the relative proportions of various constituents of dried plant extracts.

FIG. 7 shows the retention of a flavoring substance of compositions according to some aspects presented herein. The standard deviation of flavor retention for these samples is <0.8%.

FIG. 8 shows the concentration of oxidation products over time in storage of compositions according to some aspects presented herein, containing either 7.5% juice solids (panel a), or 15% juice solids (panel b). OPs stands for oxidation products including limonene oxide, carvone, trans-carveol and cis-carveol.

### DETAILED DESCRIPTION

In the following description, reference is made to specific embodiments which may be practiced, which is shown by way of illustration. These embodiments are described in detail to enable those skilled in the art to practice the invention described herein, and it is to be understood that other embodiments may be utilized and that logical changes may be made without departing from the scope of the aspects presented herein. The following description of example embodiments is, therefore, not to be taken in a limited sense, and the scope of the various aspects presented herein is defined by the appended claims.

The Abstract is provided to comply with 37 C.F.R. § 1.72 (b) to allow the reader to quickly ascertain the nature and gist of the technical disclosure. The Abstract is submitted with the understanding that it will not be used to interpret or limit the scope or meaning of the claims.

As used herein, the term “clean label” refers to flavor delivery systems that do not contain artificial flavors, artificial colors and synthetic ingredients.

A need exists for clean label spray dried, or extruded flavors. Spray dried, or extruded flavors comprising starch derivatives, such as, for example, maltodextrin, whilst having acceptable shelf lives, are not considered clean label. On the other hand, spray dried, or extruded flavors comprising food biopolymers, such as, for example, gum arabic, while clean label, often have poor shelf lives.

Without intending to be limited to any particular theory, loss and/or oxidation of the hedonic component results in the reduction of the shelf life. Due to loss or oxidation of the hedonic component, the shelf life of conventional products based on biopolymers often fails to exceed 18 months. For citrus flavoring substances, which are especially sensitive to oxygen, the shelf life is reduced even further, namely, less than 12 months.

In some aspects, the shelf life of the composition may be 2 years or more. Alternatively, the shelf life of the composition may be 1, or 2, or 3, or 4, or 5, or 6, or 7, or 8, or 9, or 10, or 11, or 12, or 13, or 14, or 15, or 16, of 17, or 18, or 19, or 20, or 21, or 22, or 23, or 24 months, or more.

The Hedonic Component: As used herein, the term “hedonic component” refers to compounds that are well known to a person skilled in the art of aromatizing, as those that are capable of imparting a flavor or taste to a consumer product, or of modifying the taste and/or flavor of the consumer product, or yet, the texture or mouthfeel of the consumer product.

In some aspects, the hedonic component is subject to oxidation (“oxidizable). In some aspects components characterized by a log P value of 2 or more.

Hedonic components that are derived from, or based on fruits where citric acid is the predominant, naturally-occurring acid include but are not limited to, for example, citrus fruits (e.g., lemon, lime), limonene, strawberry, orange, and pineapple. In some aspects, the hedonic component is lemon, lime or orange juice extracted directly from the fruit. Alternatively, in some aspects, the hedonic component comprises the juice or liquid extracted from oranges, lemons, grapefruits, key limes, citrons, clementines, mandarins, tangerines, and any other citrus fruit, or variation or hybrid thereof.

According to an embodiment, the hedonic component is an oil.

Accordingly, some aspects presented herein provide a composition, wherein the composition is a solid, the composition comprising:
a) a biopolymer selected from the group consisting of: a starch, a natural gum derived from a botanical source, a natural gum derived from seaweed, a natural gums derived from bacterial fermentation; a protein derived from plants, and a polysaccharide derived from plants; and
b) a flavor, comprising:
   i. at least one stabilizer, and
   ii. a hedonic component,
      wherein the hedonic component comprises from 10% to 30% of the composition,
      wherein the at least one stabilizer comprises from 4.5% to 27% of the composition, and
      wherein the biopolymer comprises from 49% to 85.5% of the composition.

In some aspects, the hedonic component comprises from 10% to 30% of the composition. In some aspects, the hedonic component comprises from 11% to 30% of the composition. In some aspects, the hedonic component comprises from 12% to 30% of the composition. In some aspects, the hedonic component comprises from 13% to 30% of the composition. In some aspects, the hedonic component comprises from 14% to 30% of the composition. In some aspects, the hedonic component comprises from 15% to 30% of the composition. In some aspects, the hedonic component comprises from 16% to 30% of the composition. In some aspects, the hedonic component comprises from 17% to 30% of the composition. In some aspects, the hedonic component comprises from 18% to 30% of the composition. In some aspects, the hedonic component comprises from 19% to 30% of the composition. In some aspects, the hedonic component comprises from 20% to 30% of the composition. In some aspects, the hedonic component comprises from 21% to 30% of the composition. In some aspects, the hedonic component comprises from 22% to 30% of the composition. In some aspects, the hedonic component comprises from 23% to 30% of the composition. In some aspects, the hedonic component comprises from 24% to 30% of the composition. In some aspects, the hedonic component comprises from 25% to 30% of the composition. In some aspects, the hedonic component comprises from 26% to 30% of the composition. In some aspects, the hedonic component comprises from 27% to 30% of the composition. In some aspects, the hedonic component comprises from 28% to 30% of the composition. In some aspects, the hedonic component comprises from 29% to 30% of the composition.

In some aspects, the hedonic component comprises from 10% to 29% of the composition. In some aspects, the hedonic component comprises from 10% to 28% of the composition. In some aspects, the hedonic component comprises from 10% to 27% of the composition. In some aspects, the hedonic component comprises from 10% to 26% of the composition. In some aspects, the hedonic component comprises from 10% to 25% of the composition. In some aspects, the hedonic component comprises from 10% to 24% of the composition. In some aspects, the hedonic component comprises from 10% to 23% of the composition. In some aspects, the hedonic component comprises from 10% to 22% of the composition. In some aspects, the hedonic component comprises from 10% to 21% of the composition. In some aspects, the hedonic component comprises from 10% to 20% of the composition. In some aspects, the hedonic component comprises from 10% to 19% of the composition. In some aspects, the hedonic component comprises from 10% to 18% of the composition. In some aspects, the hedonic component comprises from 10% to 17% of the composition. In some aspects, the hedonic component comprises from 10% to 16% of the composition. In some aspects, the hedonic component comprises from 10% to 15% of the composition. In some aspects, the hedonic component comprises from 10% to 14% of the composition. In some aspects, the hedonic component comprises from 10% to 13% of the composition. In some aspects, the hedonic component comprises from 10% to 12% of the composition. In some aspects, the hedonic component comprises from 10% to 11% of the composition.

In some aspects, the hedonic component comprises 10, or 11, or 12, or 13, or 14, or 15, or 16, or 17, or 18, or 19, or 20, or 21, or 22, or 23, or 24, or 25, or 26, or 27, or 28, or 29, or 30% of the composition.

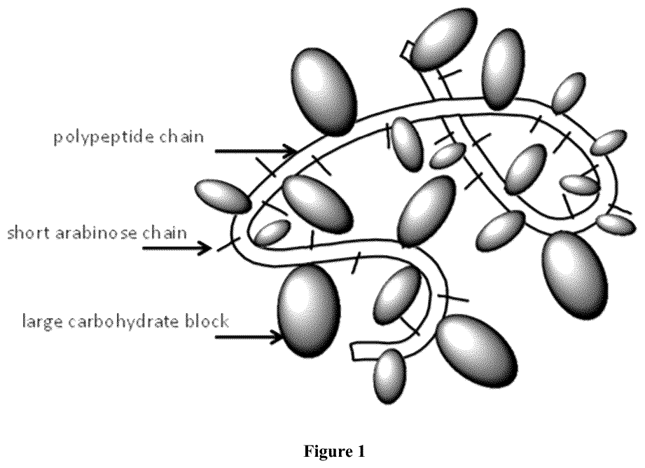

Referring to FIG. 1 (adapted from “T. Mahendran, P. A. Williams, G. O. Phillips, S. Al-Assaf, T. C. Baldwin. New insights into the structural characteristics of the arabinogalactan-protein fraction of gum arabic. Journal of Agriculture and Food Chemistry, 2008, 56, 9269-9276.”), using gum arabic as a non-limiting illustration, and without intending to be limited to any particular theory, gum arabic is dried exudation from branches and stem of Acacia senegal or Acacia seyal. Gum arabic comprises three main molecular fractions: arabinogalactan (AG) representing approximately 90% wt of the gum and containing less than 1% wt protein, arabinoglactan-protein (AGP) representing approximately 10% wt of the gum and containing approximately 10% wt protein, and glycoprotein (GP) representing approximately 1% wt of the gum and containing 25-40% wt protein.

AGP has a molecular mass of approximately 1×10⁶ Da and functions as an emulsifier. AGP consists of a polypeptide chain with large carbohydrate blocks and short arabinose groups attached.

Without intending to be limited to any particular theory, the loss of the hedonic component is via oxidation, or evaporation, or a combination thereof. In some aspects, the composition reduces the loss of the hedonic component by including a stabilizing agent. Without intending to be limited to any particular theory, in some aspects, the stabilizing agent decreases the specific volume of the biopolymer (namely the interstitial spaces between the polypeptide chains), thereby decreasing the rate of evaporation of the hedonic component, the oxidation of the hedonic component, or the combination of evaporation and oxidation of the hedonic component.

The composition may be prepared by any suitable method readily selected by one of ordinary skill in the art. Non-limiting examples of methods include extrusion, spray drying, and the like.

In some aspects, the composition is prepared by spray drying according to the methods disclosed in U.S. Patent Application Publication No. 2015/0374018 A1.

When prepared by spray-drying, the composition of the invention may be prepared by a method comprising the steps of:
(i) preparing an emulsion comprising the hedonic component, the stabilizer, the biopolymer and water, and
(ii) spray-drying the emulsion of step (i).

The emulsion may comprise between 20 and 80% of water based on the total weight of the emulsion.

The emulsion may comprise from 10% to 30% of the hedonic component, from 4.5% to 27% of the at least one stabilizer and from 49% to 85.5% of the biopolymer by weight based on the total weight of dry matter of the emulsion. It should be understood that water is not included in the dry matter of the emulsion.

The emulsion can be formed using any known emulsifying method, such as high shear mixing, sonication or homogenization. Such emulsifying methods are well known to the person skilled in the art.

In some aspects, the composition is prepared by twin-screw extrusion according to the methods disclosed in International Patent Application Publication No. WO 2016/102426 A1.

The Biopolymer: In some aspects, the biopolymer is selected from the group consisting of a starch, a natural gum derived from a botanical source, a natural gum derived from seaweed, a natural gum derived from bacterial fermentation; a protein derived from plants, a polysaccharide derived from plants, and combinations thereof.

In some aspects, the composition is free of modified starch and/or maltodextrin.

As used herein, the term “natural gum” refers to a polysaccharide of natural origin capable of causing a large increase in a solution's viscosity, even at small concentrations. In the food industry they are used as thickening agents, gelling agents, emulsifying agents, and stabilizers.

Natural gums may be uncharged polysaccharides, or, alternatively, ionic polysaccharides (also referred to herein as polyelectrolytes). In some aspects, the natural gum is an ionic polysaccharide.

In some aspects, the ionic polysaccharide is selected from the group consisting of: gum arabic, gum ghatti, gum tragacanth, Karaya gum, alginate, agar, carrageenan, gellan gum, and combinations thereof.

In some aspects, the natural gum derived from a botanical source is selected from the group consisting of: gum arabic, gum ghatti, gum tragacanth, Karaya gum, inulin, and combinations thereof.

In some aspects, the natural gum derived from a seaweed is selected from the group consisting of: alginate, agar, and carrageenan.

In some aspects, the natural gum derived from bacterial fermentation is gellan gum.

In some aspects, the protein derived from plants is soy protein.

In some aspects, the polysaccharide derived from plants is soy polysaccharides.

In some aspects, the biopolymer comprises from 49% to 85.5% of the composition. In some aspects, the biopolymer comprises from 49.5% to 85.5% of the composition. In some aspects, the biopolymer comprises from 50% to 85.5% of the composition. In some aspects, the biopolymer comprises from 50.5% to 85.5% of the composition. In some aspects, the biopolymer comprises from 51% to 85.5% of the composition. In some aspects, the biopolymer comprises from 51.5% to 85.5% of the composition. In some aspects, the biopolymer comprises from 52% to 85.5% of the composition. In some aspects, the biopolymer comprises from 52.5% to 85.5% of the composition. In some aspects, the biopolymer comprises from 53% to 85.5% of the composition. In some aspects, the biopolymer comprises from 53.5% to 85.5% of the composition. In some aspects, the biopolymer comprises from 54% to 85.5% of the composition. In some aspects, the biopolymer comprises from 54.5% to 85.5% of the composition. In some aspects, the biopolymer comprises from 55% to 85.5% of the composition. In some aspects, the biopolymer comprises from 55.5% to 85.5% of the composition. In some aspects, the biopolymer comprises from 56% to 85.5% of the composition. In some aspects, the biopolymer comprises from 56.5% to 85.5% of the composition. In some aspects, the biopolymer comprises from 57% to 85.5% of the composition. In some aspects, the biopolymer comprises from 57.5% to 85.5% of the composition. In some aspects, the biopolymer comprises from 58% to 85.5% of the composition. In some aspects, the biopolymer comprises from 58.5% to 85.5% of the composition. In some aspects, the biopolymer comprises from 59% to 85.5% of the composition. In some aspects, the biopolymer comprises from 59.5% to 85.5% of the composition. In some aspects, the biopolymer comprises from 60% to 85.5% of the composition. In some aspects, the biopolymer comprises from 60.5% to 85.5% of the composition. In some aspects, the biopolymer comprises from 61% to 85.5% of the composition. In some aspects, the biopolymer comprises from 61.5% to 85.5% of the composition. In some aspects, the biopolymer comprises from 62% to 85.5% of the composition. In some aspects, the biopolymer comprises from 62.5% to 85.5% of the composition. In some aspects, the biopolymer comprises from 63% to 85.5% of the composition. In some aspects, the biopolymer comprises from 63.5% to 85.5% of the composition. In some aspects, the biopolymer comprises from 64% to 85.5% of the composition. In some aspects, the biopolymer comprises from 64.5% to 85.5% of the composition. In some aspects, the biopolymer comprises from 65% to 85.5% of the composition. In some aspects, the biopolymer comprises from 65.5% to 85.5% of the composition. In some aspects, the biopolymer comprises from 66% to 85.5% of the composition. In some aspects, the biopolymer comprises from 66.5% to 85.5% of the composition. In some aspects, the biopolymer comprises from 67% to 85.5% of the composition. In some aspects, the biopolymer comprises from 67.5% to 85.5% of the composition. In some aspects, the biopolymer comprises from 68% to 85.5% of the composition. In some aspects, the biopolymer comprises from 68.5% to 85.5% of the composition. In some aspects, the biopolymer comprises from 69% to 85.5% of the composition. In some aspects, the biopolymer comprises from 69.5% to 85.5% of the composition. In some aspects, the biopolymer comprises from 70% to 85.5% of the composition. In some aspects, the biopolymer comprises from 70.5% to 85.5% of the composition. In some aspects, the biopolymer comprises from 71% to 85.5% of the composition. In some aspects, the biopolymer comprises from 71.5% to 85.5% of the composition. In some aspects, the biopolymer comprises from 72% to 85.5% of the composition. In some aspects, the biopolymer comprises from 72.5% to 85.5% of the composition. In some aspects, the biopolymer comprises from 73% to 85.5% of the composition. In some aspects, the biopolymer comprises from 73.5% to 85.5% of the composition. In some aspects, the biopolymer comprises from 74% to 85.5% of the composition. In some aspects, the biopolymer comprises from 74.5% to 85.5% of the composition. In some aspects, the biopolymer comprises from 75% to 85.5% of the composition. In some aspects, the biopolymer comprises from 75.5% to 85.5% of the composition. In some aspects, the biopolymer comprises from 76% to 85.5% of the composition. In some aspects, the biopolymer comprises from 76.5% to 85.5% of the composition. In some aspects, the biopolymer comprises from 77% to 85.5% of the composition. In some aspects, the biopolymer comprises from 77.5% to 85.5% of the composition. In some aspects, the biopolymer comprises from 78% to 85.5% of the composition. In some aspects, the biopolymer comprises from 78.5% to 85.5% of the composition. In some aspects, the biopolymer comprises from 79% to 85.5% of the composition. In some aspects, the biopolymer comprises from 79.5% to 85.5% of the composition. In some aspects, the biopolymer comprises from 80% to 85.5% of the composition. In some aspects, the biopolymer comprises from 80.5% to 85.5% of the composition. In some aspects, the biopolymer comprises from 81% to 85.5% of the composition. In some aspects, the biopolymer comprises from 81.5% to 85.5% of the composition. In some aspects, the biopolymer comprises from 82% to 85.5% of the composition. In some aspects, the biopolymer comprises from 82.5% to 85.5% of the composition. In some aspects, the biopolymer comprises from 83% to 85.5% of the composition. In some aspects, the biopolymer comprises from 83.5% to 85.5% of the composition. In some aspects, the biopolymer comprises from 84% to 85.5% of the composition. In some aspects, the biopolymer comprises from 84.5% to 85.5% of the composition.

In some aspects, the biopolymer comprises from 49% to 85% of the composition. In some aspects, the biopolymer comprises from 49% to 84.5% of the composition. In some aspects, the biopolymer comprises from 49% to 84% of the composition. In some aspects, the biopolymer comprises from 49% to 83.5% of the composition. In some aspects, the biopolymer comprises from 49% to 82% of the composition. In some aspects, the biopolymer comprises from 49% to 81.5% of the composition. In some aspects, the biopolymer comprises from 49% to 80% of the composition. In some aspects, the biopolymer comprises from 49% to 79.5% of the composition. In some aspects, the biopolymer comprises from 49% to 79% of the composition. In some aspects, the biopolymer comprises from 49% to 78.5% of the composition. In some aspects, the biopolymer comprises from 49% to 78% of the composition. In some aspects, the biopolymer comprises from 49% to 77.5% of the composition. In some aspects, the biopolymer comprises from 49% to 77% of the composition. In some aspects, the biopolymer comprises from 49% to 76.5% of the composition. In some aspects, the biopolymer comprises from 49% to 76% of the composition. In some aspects, the biopolymer comprises from 49% to 75.5% of the composition. In some aspects, the biopolymer comprises from 49% to 75% of the composition. In some aspects, the biopolymer comprises from 49% to 74.5% of the composition. In some aspects, the biopolymer comprises from 49% to 74% of the composition. In some aspects, the biopolymer comprises from 49% to 73.5% of the composition. In some aspects, the biopolymer comprises from 49% to 73% of the composition. In some aspects, the biopolymer comprises from 49% to 72.5% of the composition. In some aspects, the biopolymer comprises from 49% to 72% of the composition. In some aspects, the biopolymer comprises from 49% to 71.5% of the composition. In some aspects, the biopolymer comprises from 49% to 71% of the composition. In some aspects, the biopolymer comprises from 49% to 70.5% of the composition. In some aspects, the biopolymer comprises from 49% to 70% of the composition. In some aspects, the biopolymer comprises from 49% to 69.5% of the composition. In some aspects, the biopolymer comprises from 49% to 69% of the composition. In some aspects, the biopolymer comprises from 49% to 68.5% of the composition. In some aspects, the biopolymer comprises from 49% to 68% of the composition. In some aspects, the biopolymer comprises from 49% to 67.5% of the composition. In some aspects, the biopolymer comprises from 49% to 67% of the composition. In some aspects, the biopolymer comprises from 49% to 66.5% of the composition. In some aspects, the biopolymer comprises from 49% to 66% of the composition. In some aspects, the biopolymer comprises from 49% to 65.5% of the composition. In some aspects, the biopolymer comprises from 49% to 65% of the composition. In some aspects, the biopolymer comprises from 49% to 64.5% of the composition. In some aspects, the biopolymer comprises from 49% to 64% of the composition. In some aspects, the biopolymer comprises from 49% to 63.5% of the composition. In some aspects, the biopolymer comprises from 49% to 63% of the composition. In some aspects, the biopolymer comprises from 49% to 62.5% of the composition. In some aspects, the biopolymer comprises from 49% to 62% of the composition. In some aspects, the biopolymer comprises from 49% to 61.5% of the composition. In some aspects, the biopolymer comprises from 49% to 61% of the composition. In some aspects, the biopolymer comprises from 49% to 60.5% of the composition. In some aspects, the biopolymer comprises from 49% to 60% of the composition. In some aspects, the biopolymer comprises from 49% to 59.5% of the composition. In some aspects, the biopolymer comprises from 49% to 59% of the composition. In some aspects, the biopolymer comprises from 49% to 58.5% of the composition. In some aspects, the biopolymer comprises from 49% to 58% of the composition. In some aspects, the biopolymer comprises from 49% to 57.5% of the composition. In some aspects, the biopolymer comprises from 49% to 57% of the composition. In some aspects, the biopolymer comprises from 49% to 56.5% of the composition. In some aspects, the biopolymer comprises from 49% to 56% of the composition. In some aspects, the biopolymer comprises from 49% to 55.5% of the composition. In some aspects, the biopolymer comprises from 49% to 55% of the composition. In some aspects, the biopolymer comprises from 49% to 54.5% of the composition. In some aspects, the biopolymer comprises from 49% to 54% of the composition. In some aspects, the biopolymer comprises from 49% to 53.5% of the composition. In some aspects, the biopolymer comprises from 49% to 53% of the composition. In some aspects, the biopolymer comprises from 49% to 52.5% of the composition. In some aspects, the biopolymer comprises from 49% to 52% of the composition. In some aspects, the biopolymer comprises from 49% to 51.5% of the composition. In some aspects, the biopolymer comprises from 49% to 51% of the composition. In some aspects, the biopolymer comprises from 49% to 50.5% of the composition. In some aspects, the biopolymer comprises from 49% to 50% of the composition. In some aspects, the biopolymer comprises from 49.5% to 50% of the composition.
In some aspects, the biopolymer comprises 49, or 49.5, or 50, or 50.5, or 51, or 51.5, or 52, or 52.5, or 53, or 53.5, or 54, or 54.5, or 55, or 55.5, or 56, or 56.5, or 57, or 57.5, or 58, or 58.5, or 59, or 59.5, or 60, or 60.5, or 61, or 61.5, or 62, or 62.5, or 63, or 63.5, or 64, or 64.5, or 65, or 65.5, or 66, or 66.5, or 67, or 67.5, or 68, or 68.5, or 69, or 69.5, or 70, or 70.5, or 71, or 71.5, or 72, or 72.5, or 73, or 73.5, or 74, or 74.5, or 75, or 75.5, or 76, or 76.5, or 77, or 77.5, or 78, or 78.5, or 79, or 79.5, or 80, or 80.5, or 81, or 81.5, or 82, or 82.5, or 83, or 83.5, or 84, or 84.5, or 85, or 85.5% of the composition.
The at Least One Stabilizer: In some aspects, the at least one stabilizer is selected from the group consisting of: a plant extract, an organic acid, an organic acid salt, a sugar, honey, and combinations thereof.

The plant extract can be dried or liquid. According to a particular embodiment, the plant extract is dried.

In some aspects, the at least one stabilizer is a sugar. In some aspects, the sugar is selected from the group consisting of: fructose, glucose, sucrose, maltose, and combinations thereof.

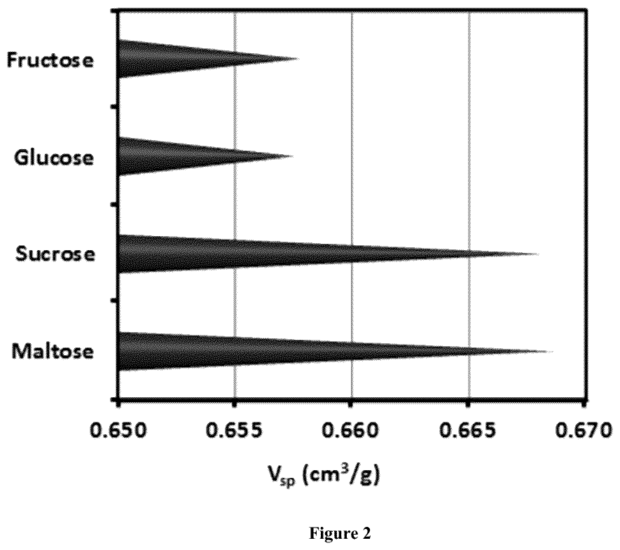

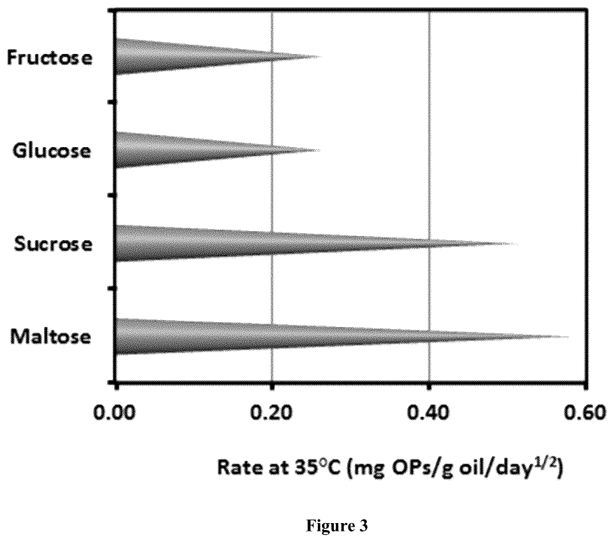

Referring to Example 1 and FIGS. 2 and 3, the use of sugar as the at least one stabilizer decrease the oxidation of the hedonic component.

In some aspects, the at least one stabilizer is an organic acid. In some aspects, the organic acid is selected from the group consisting of: citric acid, malic acid, ascorbic acid, tartaric acid, and combinations thereof.

It has been shown that when organic acid is used in a high amount, a slow active ingredient release can be observed.

In some aspects, the organic acid is used in an amount greater than 12% by weight based on the total weight of the composition.

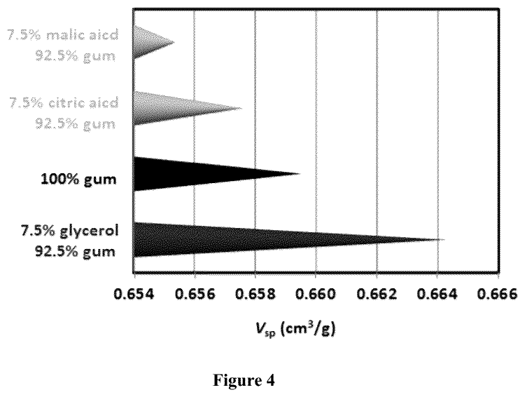

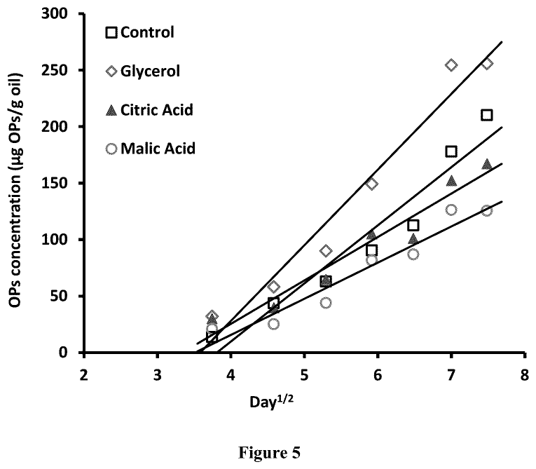

Referring to Example 2 and FIGS. 4 and 5, the use of an organic acid as the at least one stabilizer decrease the oxidation of the hedonic component.

In some aspects, the plant extract is a juice extract.

In some aspects, the plant extract is dried and is a juice extract. Juice extract encompasses juice extract of vegetables and/or fruits.

In some aspects, the dried plant extract is selected from the group consisting of: a pear extract, a citrus fruit extract, a grape extract, a tree sap, and combinations thereof.

In some aspects, the citrus fruit extract is selected from the group consisting of: an orange extract and a lemon extract.

In some aspects, the tree sap is maple syrup.

In some aspects, the plant extract comprises a mixture of monosaccharides and disaccharides and optionally organic acids.

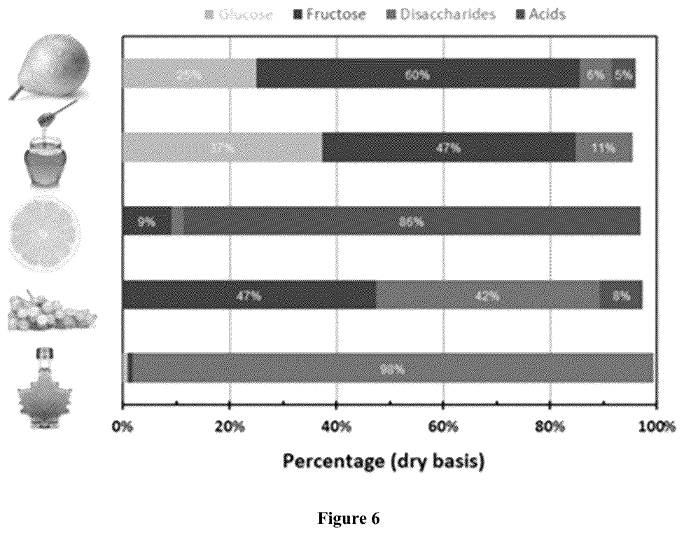

Referring to Example 3 and FIG. 6, in some aspects, the dried plant extract comprises a mixture of organic acids, monosaccharides and disaccharides.

In some aspects, the dried plant extract comprises from 5 to 90% organic acid.

In some aspects, the dried plant extract comprises from 1 to 99% disaccharide.

In some aspects, the dried plant extract comprises from 1 to 60% fructose.

In some aspects, the dried plant extract comprises from 1 to 40% glucose.

In some aspects, the dried plant extract comprises 25% glucose, 60% fructose, 6% disaccharide, and 5% organic acids.

In some aspects, the dried plant extract comprises 37% glucose, 47% fructose, and 11% disaccharide.

In some aspects, the dried plant extract comprises 9% fructose, 5% disaccharide, and 86% organic acids.

In some aspects, the dried plant extract comprises 47% fructose, 42% disaccharide, and 8% organic acids.

In some aspects, the dried plant extract comprises 98% disaccharides, with the remainder comprising glucose and fructose.

In some aspects, the at least one stabilizer comprises from 4.5 to 27% of the composition. In some aspects, the at least one stabilizer comprises from 5 to 27% of the composition. In some aspects, the at least one stabilizer comprises from 5.5 to 27% of the composition. In some aspects, the at least one stabilizer comprises from 6 to 27% of the composition. In some aspects, the at least one stabilizer comprises from 6.5 to 27% of the composition. In some aspects, the at least one stabilizer comprises from 7 to 27% of the composition. In some aspects, the at least one stabilizer comprises from 7.5 to 27% of the composition. In some aspects, the at least one stabilizer comprises from 8 to 27% of the composition. In some aspects, the at least one stabilizer comprises from 8.5 to 27% of the composition. In some aspects, the at least one stabilizer comprises from 9 to 27% of the composition. In some aspects, the at least one stabilizer comprises from 9.5 to 27% of the composition. In some aspects, the at least one stabilizer comprises from 10 to 27% of the composition. In some aspects, the at least one stabilizer comprises from 10.5 to 27% of the composition. In some aspects, the at least one stabilizer comprises from 11 to 27% of the composition. In some aspects, the at least one stabilizer comprises from 11.5 to 27% of the composition. In some aspects, the at least one stabilizer comprises from 12 to 27% of the composition. In some aspects, the at least one stabilizer comprises from 12.5 to 27% of the composition. In some aspects, the at least one stabilizer comprises from 13 to 27% of the composition. In some aspects, the at least one stabilizer comprises from 13.5 to 27% of the composition. In some aspects, the at least one stabilizer comprises from 14 to 27% of the composition. In some aspects, the at least one stabilizer comprises from 14.5 to 27% of the composition. In some aspects, the at least one stabilizer comprises from 15 to 27% of the composition. In some aspects, the at least one stabilizer comprises from 15.5 to 27% of the composition. In some aspects, the at least one stabilizer comprises from 16 to 27% of the composition. In some aspects, the at least one stabilizer comprises from 16.5 to 27% of the composition. In some aspects, the at least one stabilizer comprises from 17 to 27% of the composition. In some aspects, the at least one stabilizer comprises from 17.5 to 27% of the composition. In some aspects, the at least one stabilizer comprises from 18 to 27% of the composition. In some aspects, the at least one stabilizer comprises from 18.5 to 27% of the composition. In some aspects, the at least one stabilizer comprises from 19 to 27% of the composition. In some aspects, the at least one stabilizer comprises from 19.5 to 27% of the composition. In some aspects, the at least one stabilizer comprises from 20 to 27% of the composition. In some aspects, the at least one stabilizer comprises from 20.5 to 27% of the composition. In some aspects, the at least one stabilizer comprises from 21 to 27% of the composition. In some aspects, the at least one stabilizer comprises from 21.5 to 27% of the composition. In some aspects, the at least one stabilizer comprises from 22 to 27% of the composition. In some aspects, the at least one stabilizer comprises from 22.5 to 27% of the composition. In some aspects, the at least one stabilizer comprises from 23 to 27% of the composition. In some aspects, the at least one stabilizer comprises from 23.5 to 27% of the composition. In some aspects, the at least one stabilizer comprises from 24 to 27% of the composition. In some aspects, the at least one stabilizer comprises from 24.5 to 27% of the composition. In some aspects, the at least one stabilizer comprises from 25 to 27% of the composition. In some aspects, the at least one stabilizer comprises from 25.5 to 27% of the composition. In some aspects, the at least one stabilizer comprises from 26 to 27% of the composition. In some aspects, the at least one stabilizer comprises from 26.5 to 27% of the composition.

In some aspects, the at least one stabilizer comprises from 4.5 to 26.5% of the composition. In some aspects, the at least one stabilizer comprises from 4.5 to 26% of the composition. In some aspects, the at least one stabilizer comprises from 4.5 to 25.5% of the composition. In some aspects, the at least one stabilizer comprises from 4.5 to 25% of the composition. In some aspects, the at least one stabilizer comprises from 4.5 to 24.5% of the composition. In some aspects, the at least one stabilizer comprises from 4.5 to 24% of the composition. In some aspects, the at least one stabilizer comprises from 4.5 to 23.5% of the composition. In some aspects, the at least one stabilizer comprises from 4.5 to 23% of the composition. In some aspects, the at least one stabilizer comprises from 4.5 to 22.5% of the composition. In some aspects, the at least one stabilizer comprises from 4.5 to 22% of the composition. In some aspects, the at least one stabilizer comprises from 4.5 to 21.5% of the composition. In some aspects, the at least one stabilizer comprises from 4.5 to 21% of the composition. In some aspects, the at least one stabilizer comprises from 4.5 to 20.5% of the composition. In some aspects, the at least one stabilizer comprises from 4.5 to 20% of the composition. In some aspects, the at least one stabilizer comprises from 4.5 to 19.5% of the composition. In some aspects, the at least one stabilizer comprises from 4.5 to 19% of the composition. In some aspects, the at least one stabilizer comprises from 4.5 to 18.5% of the composition. In some aspects, the at least one stabilizer comprises from 4.5 to 18% of the composition. In some aspects, the at least one stabilizer comprises from 4.5 to 17.5% of the composition. In some aspects, the at least one stabilizer comprises from 4.5 to 17% of the composition. In some aspects, the at least one stabilizer comprises from 4.5 to 16.5% of the composition. In some aspects, the at least one stabilizer comprises from 4.5 to 16% of the composition. In some aspects, the at least one stabilizer comprises from 4.5 to 15.5% of the composition. In some aspects, the at least one stabilizer comprises from 4.5 to 15% of the composition. In some aspects, the at least one stabilizer comprises from 4.5 to 14.5% of the composition. In some aspects, the at least one stabilizer comprises from 4.5 to 14% of the composition. In some aspects, the at least one stabilizer comprises from 4.5 to 13.5% of the composition. In some aspects, the at least one stabilizer comprises from 4.5 to 13% of the composition. In some aspects, the at least one stabilizer comprises from 4.5 to 12.5% of the composition. In some aspects, the at least one stabilizer comprises from 4.5 to 12% of the composition. In some aspects, the at least one stabilizer comprises from 4.5 to 11.5% of the composition. In some aspects, the at least one stabilizer comprises from 4.5 to 11% of the composition. In some aspects, the at least one stabilizer comprises from 4.5 to 10.5% of the composition. In some aspects, the at least one stabilizer comprises from 4.5 to 10% of the composition. In some aspects, the at least one stabilizer comprises from 4.5 to 9.5% of the composition. In some aspects, the at least one stabilizer comprises from 4.5 to 9% of the composition. In some aspects, the at least one stabilizer comprises from 4.5 to 8.5% of the composition. In some aspects, the at least one stabilizer comprises from 4.5 to 8% of the composition. In some aspects, the at least one stabilizer comprises from 4.5 to 7.5% of the composition. In some aspects, the at least one stabilizer comprises from 4.5 to 7% of the composition. In some aspects, the at least one stabilizer comprises from 4.5 to 6.5% of the composition. In some aspects, the at least one stabilizer comprises from 4.5 to 6% of the composition. In some aspects, the at least one stabilizer comprises from 4.5 to 5.5% of the composition. In some aspects, the at least one stabilizer comprises from 4.5 to 5% of the composition.

In some aspects, the at least one stabilizer comprises 4.5, or 5, or 5.5, or 6, or 6.5, or 7, or 7.5, or 8, or 8.5, or 9, or 9.5, or 10, or 10.5, or 11, or 11.5, or 12, or 12.5, or 13, or 13.5, or 14, or 14.5, or 15, or 15.5, or 16, or 16.5, or 17, or 17.5, or 18, or 18.5, or 19, or 19.5, or 20, or 20.5, or 21, or 21.5, or 22, or 22.5, or 23, or 23.5, or 24, or 24.5, or 25, or 25.5, or 26, or 26.5, or 27% of the composition.

Some aspects presented herein provide a flavor, comprising:
a) at least one stabilizer, and
b) a hedonic component,
   wherein the at least one stabilizer comprises from 10% to 75% of the flavor, and
   wherein the hedonic component comprises from 15% to 90% of the flavor.
      In some aspects, the at least one stabilizer comprises from 10% to 70% of the flavor. In some aspects, the at least one stabilizer comprises from 10% to 65% of the flavor. In some aspects, the at least one stabilizer comprises from 10% to 60% of the flavor. In some aspects, the at least one stabilizer comprises from 10% to 55% of the flavor. In some aspects, the at least one stabilizer comprises from 10% to 50% of the flavor. In some aspects, the at least one stabilizer comprises from 10% to 45% of the flavor. In some aspects, the at least one stabilizer comprises from 10% to 40% of the flavor. In some aspects, the at least one stabilizer comprises from 10% to 35% of the flavor. In some aspects, the at least one stabilizer comprises from 10% to 30% of the flavor. In some aspects, the at least one stabilizer comprises from 10% to 25% of the flavor. In some aspects, the at least one stabilizer comprises from 10% to 20% of the flavor. In some aspects, the at least one stabilizer comprises from 10% to 15% of the flavor.

In some aspects, the at least one stabilizer comprises from 15% to 70% of the flavor. In some aspects, the at least one stabilizer comprises from 20% to 70% of the flavor. In some aspects, the at least one stabilizer comprises from 25% to 70% of the flavor. In some aspects, the at least one stabilizer comprises from 30% to 70% of the flavor. In some aspects, the at least one stabilizer comprises from 35% to 70% of the flavor. In some aspects, the at least one stabilizer comprises from 40% to 70% of the flavor. In some aspects, the at least one stabilizer comprises from 45% to 70% of the flavor. In some aspects, the at least one stabilizer comprises from 50% to 70% of the flavor. In some aspects, the at least one stabilizer comprises from 55% to 70% of the flavor. In some aspects, the at least one stabilizer comprises from 60% to 70% of the flavor. In some aspects, the at least one stabilizer comprises from 65% to 70% of the flavor.

In some aspects, the at least one stabilizer comprises 15, or 20, or 25, or 30, or 35, or 40, or 45, or 50, or 55, or 60, or 65, or 70% of the flavor.

In some aspects, the flavor is further combined with the biopolymer, to form a composition according to some aspects presented herein.

The Use of Compositions According to Some Aspects Presented Herein: The compositions provided herein may be suitable for conveying flavors to beverages, fluid dairy products, condiments, baked goods, frostings, bakery fillings, candy, chewing gum and other food products.

Beverages include, without limitation, carbonated soft drinks, including cola, lemon-lime, root beer, heavy citrus (“dew type”), fruit flavored and cream sodas; powdered soft drinks, as well as liquid concentrates such as fountain syrups and cordials; coffee and coffee-based drinks, coffee substitutes and cereal-based beverages; teas, including dry mix products as well as ready-to-drink teas (herbal and tealeaf based); fruit and vegetable juices and juice flavored beverages as well as juice drinks, nectars, concentrates, punches and “ades”; sweetened and flavored waters, both carbonated and still; sport/energy/health drinks; alcoholic beverages plus alcohol-free and other low-alcohol products including beer and malt beverages, cider, and wines (still, sparkling, fortified wines and wine coolers); other beverages processed with heating (infusions, pasteurization, ultra high temperature, ohmic heating or commercial aseptic sterilization) and hot-filled packaging; and cold-filled products made through filtration or other preservation techniques.

Fluid dairy products include, without limitation, non-frozen, partially frozen and frozen fluid dairy products such as, for example, milks, ice creams, sorbets and yogurts.

Condiments include, without limitation, ketchup, mayonnaise, salad dressing, Worcestershire sauce, fruit-flavored sauce, chocolate sauce, tomato sauce, chili sauce, and mustard.

Baked goods include, without limitation, cakes, cookies, pastries, breads, donuts and the like.

Bakery fillings include, without limitation, low or neutral pH fillings, high, medium or low solids fillings, fruit or milk based (pudding type or mousse type) fillings, hot or cold make-up fillings and nonfat to full-fat fillings.

Some aspects provide a powdered beverage comprising a composition according to some aspects presented herein.

Some aspects provide a sweet good comprising a composition according to some aspects presented herein.

Some aspects provide a savory good comprising a composition according to some aspects presented herein.

Some aspects provide a toothpaste comprising a composition according to some aspects presented herein.

The present invention is best illustrated but is not limited to the following examples, wherein the abbreviations have the usual meaning in the art, the temperatures are indicated in degrees centigrade (° C.).

### EXAMPLES

### Example 1: Stabilizing Agents Comprising Sugars

Compositions comprising 80% 10 DE maltodextrin and 20% sugar were spray dried with 20% orange oil. The physical properties of resultant powders are shown in Table 1. All samples had a relatively high glass transition temperature, T_{g} (74-84° C.) except the one containing 20% glucose, due to its higher moisture content (or A_{w}). Compositions comprising disaccharides had higher T_{g} values as a result of their higher number average molecular weight (Mₙ).

TABLE 1
Glass transition temperature (T_{g}) and water
activity (A_{w}) of spray dried orange oil powder
using the combination of 80% 10 DE
maltodextrin and 20% sugar as carrier.

| Sugar type | T_{g} (° C.) | A_{w} (25° C.) |
|---|---|---|
| Fructose | 74 ± 2 | 0.1960 ± 0.0006 |
| Glucose | 59 ± 1 | 0.2800 ± 0.0008 |
| Sucrose | 82 ± 2 | 0.1890 ± 0.0012 |
| Maltose | 84 ± 3 | 0.1880 ± 0.0007 |

Matrix density was measured for all fresh samples using an AccuPyc II 1340 Pycnometer with a TEC temperature control module (Micromeritics Instrument Corp., Norcross, GA, USA). Powders were milled using an IKA® A11 basic Analytical batch mill (IKA® Works, Inc., Wilmington, NC, USA). About 20 g of spray dry powder sample was weighed into the grinding beaker and the sample was then cooled by adding a portion of liquid nitrogen. Once the added liquid nitrogen was completely vaporized the material was ground for 30 sec, followed by a 1 min pause, and another 30 sec of grinding. This process of cooling and grinding was repeated until the mean particle size reached 15-20 μm after which the ground material was recovered for analysis. This milling process allows helium to fully access micro-/macro-pores originally enclosed in the particle.

Matrix specific volume (Vₛₚ) can be expressed as:

$${V}_{sp} = \frac{1}{{ρ}_{p}} - \frac{{X}_{o}}{{ρ}_{o}}$$

where ρₚ (g cm³) is the density of spray dry particles after cryo-milling, Xₒ (g oil per g powder) is the oil content, and ρₒ is the oil density (g cm³). ρₚ, Xₒ and ρₒ can be determined by helium displacement pycnometer, Time Domain-NMR and density meter, respectively.

Oxidation products (OPs, i.e. limonene oxide and carvone) were monitored during storage at 35° C. by gas chromatography (GC). The average of triplicate measurements was reported. Concentration of oxidation products (mg OPs/g oil) was plotted as a function of the square root of storage time (Day^{1/2}). A linear regression of oxidation products concentration (mg OPs/g oil) vs. the square root of storage time (Day^{1/2}) was performed. Oxidation rate is defined as the slope of the linear regression (mg OPs/g oil/day^{1/2}).

As shown in FIG. 2, compositions containing monosaccharides (glucose or fructose) exhibited a lower specific volume than those containing disaccharides (sucrose or maltose). Additionally, the oxidation rate of limonene followed the same pattern as specific volume (see FIG. 3).

Taken together, these data indicate that incorporating a monosaccharide is more effective than a disaccharide in improving the carrier barrier property against oxidation. Moreover, monosaccharides may outperform disaccharides in reducing oxidation rate when incorporated in compositions.

### Example 2: Stabilizing Agents Comprising Organic Acids

Compositions comprising gum arabic and an organic acid were spray dried with 20% orange oil, according to the proportions listed in FIG. 4. Sample with 100% gum arabic served as a control. FIG. 4 demonstrates that malic acid and citric acid decrease the specific volume of gum arabic whereas glycerol increases the specific volume of gum arabic. Oxidation products (i.e. limonene oxide and carvone) were monitored during storage at 35° C. and controlled water activity of 0.33. FIG. 5 shows that incorporating glycerol in gum arabic increased limonene oxidation whereas incorporating malic acid and citric acid in gum arabic decreased limonene oxidation. Taken together, these data suggest that incorporating an organic acid into a biopolymer will decrease the oxidation of the hedonic component.

Without intending to be limited to any particular theory, it is speculated here adding glycerol extensively disrupts hydrogen bonding between gum arabic chains by forming new hydrogen bonding between gum arabic and glycerol. As a consequence, the polymeric chains open up resulting in greater molecular mobility. On the contrary, organic acid and sugars are relatively bigger molecules. Incorporating these larger molecules has less disruption of hydrogen bonding between polymer chains and instead it greatly reduces molecular entanglement between polymer chains and thus decreases molecular mobility.

### Example 3: Stabilizing Agents Comprising Dried Plant Extract

Compositions comprising gum arabic and extracts comprising dried plant extract were spray dried with 16% orange oil, as set forth in Table 2. A control composition comprising 90% 18 DE maltodextrin and 10% Capsul® (a modified food starch) was also produced with the same load of orange oil.

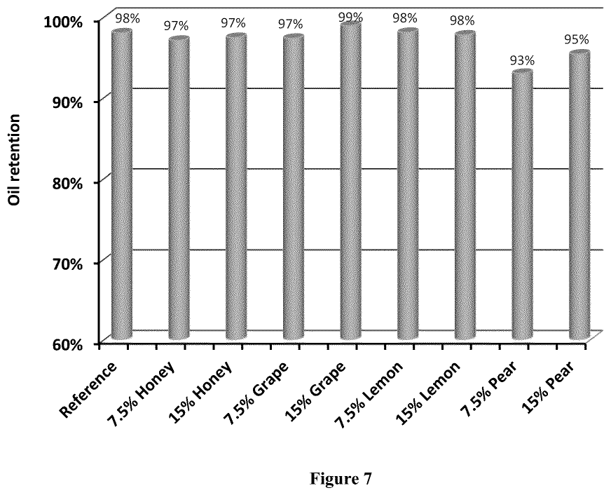

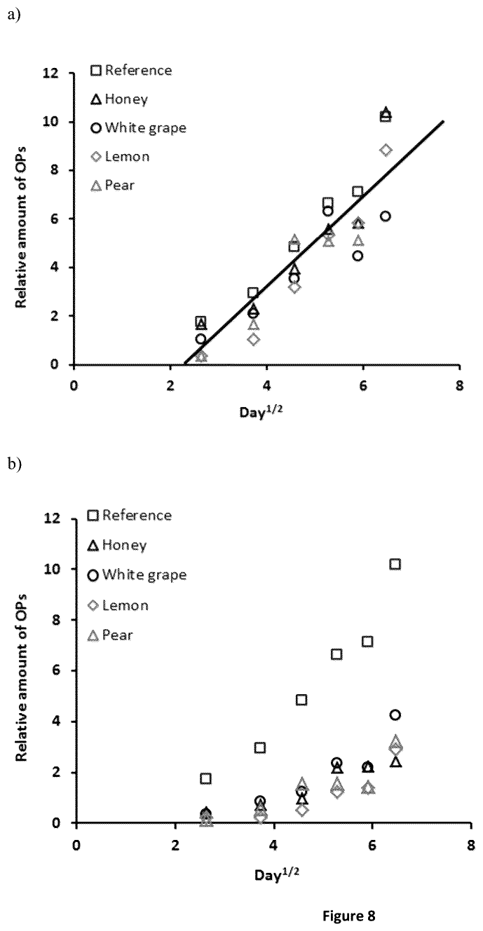

Referring to FIG. 7, all samples showed oil retention of greater than 93%. The oxidation stability of all spray dried powders were evaluated under accelerated conditions (35° C. and 3.5 bar oxygen) using a Parr reactor. The oxidation products (cis- and trans-limonene oxides, carvone, and cis- and trans-carveol) were quantified using solid phase microextraction and gas chromatography-mass spectrometry (SPME-GC-MS) after defined periods of time. Referring to FIG. 8, the concentration of oxidation products increased in all samples during storage regardless of the type of juice solids. Interestingly, as demonstrated by their similar oxidation rates, carriers containing 7.5% juice solids performed as well as the reference. On the other hand, adding 15% juice solids in gum arabic resulted in a far superior stability (slower oxidation rate) compared to the reference. Though chemical compositions (type of sugars and organic acids) of these juice solids are very different, a notable difference in oxidation rate was not observed indicating that type of juice solids may not be critical from stability perspective when incorporated at low levels (i.e. less than 15% wt).

TABLE 2
Type of juice solids and orange oil load used in spray dried powder.

| Juice Type | Juice Solids | Oil Load |
|---|---|---|
| [symbol] | 7.5% | 16% |
| | 15% | 16% |
| [symbol] | 7.5% | 16% |
| | 15% | 16% |
| [symbol] | 7.5% | 16% |
| | 15% | 16% |
| [symbol] | 7.5% | 16% |
| | 15% | 16% |

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

### Example 4: Preparation of a Composition According to the Invention (Extruding Process)

A BC-21 co-rotating twin screw extruder (Clextral, Firminy France, L/D=32) was used to encapsulate single fold, cold pressed orange oil into a solid particulate form. Gum arabic was fed into the extruder by means of a loss-in-weight powder feeder with a flow rate of 8.0-9.0 kg/hr. Orange oil was injected into the extruder at a flow rate of 1.0 kg/hr. Plant extracts (i.e. pear juice concentrate and white grape juice concentrate) were injected into the extruder at a flow rate of 1.0 kg/hr. Both juice concentrates contain about 70% solids and 30% water. A small amount of lubricant and water were injected into the extruder to obtain extruded particles with glass transition temperature (T_{g}) of 20-40° C. Temperature set points of the extruder barrels ranged from 20-100° C. The screw speed kept constant at 500 rpm. The carbohydrate melt was extruded through a die plate with 1-mm diameter holes. After establishing steady-state extrusion condition, particles were cut by means of rotating cutting blades/knives and particles were sieved between 710 and 1,400 μm. The samples were collected for oil content and glass transition temperature analysis.

The formulas and physical properties of extruded particles were described in Table 3. The data shows that incorporating juice concentrate in gum arabic increased oil content retained in extruded particles. Moreover, formulas with juice concentrates show lower matrix specific volume than the reference which will lead to slower oxidation rate and better shelf stability.

TABLE 3
Summary of the formulation and physical properties of extruded particles.

| | Gum arabic | Juice | Orange oil | | Retained | |
|---|---|---|---|---|---|---|
| | flow rate | flow rate | flow rate | | oil content | Matrix specific^{a} |
| Sample ID | (kg/hr) | (kg/hr) | (kg/hr) | T_{g} (° C.) | (%) | volume (cm³/g) |
| Reference | 9.0 | 0 | 1.0 | 20 | 7.7 | 0.6670 |
| White grape | 8.0 | 1.0 | 1.0 | 22 | 8.5 | 0.6627 |
| juice | | | | | | |
| concentrate | | | | | | |
| Pear juice | 8.0 | 1.0 | 1.0 | 26 | 8.4 | 0.6618 |
| concentrate | | | | | | |

^{a}the standard deviation of matrix specific volume is <0.001 cm³/g

### Example 5: Preparation of a Composition According to the Invention (Extruding Process)

A lab-scale co-rotating twin screw extruder (EuraLab, ThermoScientific, L/D=32) was used to encapsulate single fold, cold pressed orange oil into a solid particulate form. The extruder consists of 6 barrels with independent temperature control. Powders (gum arabic or a mixture of gum arabic and citric acid) were fed into the extruder at a flow rate of 0.5 kg/hr. Orange oil and water were injected into the extruder at appropriate flow rates. Barrel temperatures from feeder to die end are set as 20, 20, 20, 90, 100, 110° C. Screw speed was kept as 150 rpm. The melt was extruded through a die plate with a 1.0 mm diameter hole. Die temperature was set at 100° C. After establishing steady-state extrusion conditions, the strands exiting the die were cut by means of rotating cutting blades/knives.

The formulas and physical properties of extruded particles were described in Table 4.

TABLE 4
Summary of the formulation and physical
properties of extruded particles.

| | Feeding powder | Retained oil | Moisture | T_{g} |
|---|---|---|---|---|
| Sample | composition | content (%) | content (%) | (° C.) |
| Reference | 100% gum arabic | 8.1 | 16.2 | 28 |
| Sample #1 | 21% citric acid | 8.5 | 5.5 | 23 |
| | monohydrate and | | | |
| | 79% gum arabic | | | |

Headspace analysis using solid phase microextraction (SPME) and gas chromatography-mass spectrometry (GC-MS) was conducted for both samples. Extruded particles were added into 1000 mL water in 2 L beaker with magnetic stirring at 160 rpm/s. Small quantity solutions were taken for headspace analysis at the time interval of 0 s, 15 s, 30 s, 60 s, 120 s, 240 s, 480 s, 600 s and 720 s. The concentrations of limonene in the headspace at different time points were quantified. It was observed that the sample without citric acid had faster release and 100% limonene was release after 10-15 min. In contrast, the sample containing citric acid had much slower release and 100% limonene release occurred after 45-50 min. Therefore, incorporating citric acid in gum arabic imparted slower release properties which may be desirable in some applications.

What is claimed is:

1. A composition, wherein the composition is a solid, the composition comprising:
a. a biopolymer selected from the group consisting of: a starch, a natural gum derived from a botanical source, a natural gum derived from seaweed, a natural gum derived from bacterial fermentation; a protein derived from plants, and a polysaccharide derived from plants; and
b. a flavor, comprising:
i. at least one stabilizer, and
ii. a hedonic component,
wherein the hedonic component comprises from 10% to 30% of the composition,
wherein the at least one stabilizer comprises from 4.5% to 27% of the composition, and
wherein the biopolymer comprises from 49% to 85.5% of the composition.

2. The composition of claim 1, wherein the natural gum derived from a botanical source is selected from the group consisting of: gum arabic, gum ghatti, gum tragacanth, Karaya gum, inulin, and combinations thereof.

3. The composition according to claim 1, wherein the composition is free from maltodextrin and/or modified starch.

4. The composition according to claim 1, wherein the at least one stabilizer is selected from the group consisting of: a plant extract, an organic acid, an organic acid salt, a sugar, honey, and combinations thereof.

5. The composition according to claim 4, wherein the plant extract is a dried plant extract.

6. The composition according to claim 4, wherein the at least one stabilizer is a plant extract comprising a mixture of monosaccharides, disaccharides, and optionally organic acids.

7. The composition according to claim 4, wherein the at least one stabilizer is a plant extract comprising a mixture of monosaccharides, disaccharides, and organic acids.

8. The composition of claim 6, wherein the plant extract comprises between 0 and 90% of organic acids, between 1 and 99% of disaccharides, between 1 and 60% of fructose and between 1 and 40% of glucose.

9. The composition according to claim 4, wherein the organic acid is selected from the group consisting of: citric acid, ascorbic acid, malic acid, tartaric acid, and combinations thereof.

10. The composition according to claim 4, wherein the plant extract is a juice extract.

11. The composition of claim 10, wherein the plant extract is selected from the group consisting of: a pear extract, a citrus fruit extract, a grape extract, a tree sap, and combinations thereof.

12. The composition of claim 11, wherein the citrus fruit extract is selected from the group consisting of: an orange extract and a lemon extract.

13. The composition of claim 11, wherein the tree sap is maple syrup.

14. A flavor, comprising:
a. at least one stabilizer, and
b. a hedonic component,
wherein the at least one stabilizer comprises from 10% to 75% of the flavor, and
wherein the hedonic component comprises from 15% to 90% of the flavor.

15. A consumer product selected from the group consisting of: a powdered beverage, a sweet good, and a savory good, comprising the composition as defined in claim 1.

16. The composition of claim 8, wherein the plant extract comprises between 5 and 90% of organic acids.
